(19) United States
(12) Patent Application Publication
(10) Pub. No.: US 2003/0161336 A1
(43) Pub. Date: Aug. 28, 2003

(54) Network management system for designating a communications gateway between domains

(75) Inventors: Christophe Preguica, Massy (FR); Damien Galand, Chaville (FR)

Correspondence Address: SUGHRUE MION, PLLC, Suite 800, 2100 Pennsylvania Avenue, Washington, DC, 20037-3213, US

(73) Assignee: ALCATEL

(21) Appl. No.: 10/367,924

(22) Filed: Feb. 19, 2003

(30) Foreign Application Priority Data
Feb. 28, 2002 (FR) 02 02 548

(51) Int. Cl. H04L 12/56

(52) U.S. Cl. 370/401

(57) ABSTRACT

A network management system having means for obtaining information about equipment in the network, some of said equipment being constituted by gateways suitable for enabling traffic to be sent out from said network, the system including means for sending, to the domain name server associated with said network, the address(es) of one or more of said gateways as determined on the basis of said information.

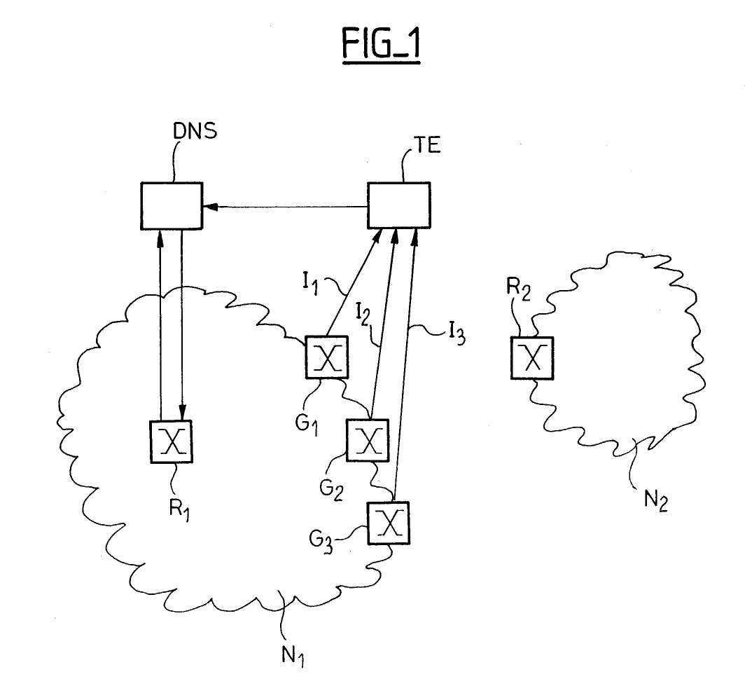

The present invention relates to sending data packets out from a data network. It applies particularly well to Internet type networks.

### BACKGROUND OF THE INVENTION

When a node of a network seeks to send a data packet out from its own network, the data packet is sent via a gateway. Conventionally, the gateway is a border router which has means for communicating both with routers that are internal to the network in question, and with routers of other networks, generally other border routers.

The node originating transmission of the data packet therefore needs to know the address of the border router gateway.

This address may be known either by configuration, or by interrogating a domain name server (DNS).

It can thus be understood that this gateway plays a critical role in sending data packets between two domains.

As a result, the gateway must be capable of handling all of the traffic sent between the two domains. This traffic can be large and can lead to the gateway becoming overloaded, with the consequence of a reduction in transmission performance between the two domains.

In addition, the gateway may suffer a hardware or software failure, and no longer be capable of sending data packets from one domain to another. In such a situation, traffic becomes impossible between the two domains.

### OBJECT AND SUMMARY OF THE INVENTION

The object of the invention is to solve that pair of problems by proposing that a plurality of gateways be arranged to send data packets between the two domains.

More precisely, the invention provides a network management system having means for obtaining information about equipment in the network, some of the equipment being constituted by gateways suitable for enabling traffic to be sent out from the network. The network management system includes means for sending, to the domain name server associated with the network, the address(s) of one or more of said gateways as determined on the basis of said information.

In an embodiment of the invention, said means are arranged to order a list of gateways prior to sending the list to the domain name server.

In an embodiment of the invention, said means implement a dynamic update command to send the address(es). This command may be designed to contain a list of addresses. For example, it may be a command of the “DNS update” type in accordance with RFC 2136.

Thus, at any given moment, either the domain name server or the router originating the transmission can decide on the “best” gateway for allowing data packets to be sent to the second domain. This makes it possible to avoid sending data packets via a gateway that has failed or that is overloaded. It is also possible to spread loading over a set of available gateways.

### BRIEF DESCRIPTION OF THE DRAWING

The invention and its advantages appear more clearly from the following description given with reference to the sole accompanying Figure which shows an embodiment of the invention.

### MORE DETAILED DESCRIPTION

In the sole Figure, a router R₁ of domain N₁ can communicate with domain N₂ via three gateways G₁, G₂, G₃. These gateways have sufficient knowledge to enable data packets to be sent between the two domains N₁ and N₂ by means of a routing protocol of the border gateway protocol (GBP) type, as defined in RFC 1771 of the Internet Engineering Task Force (IETF).

Data packets are transmitted within a domain, e.g. from router R₁ to one of the gateways G₁, G₂, G₃, for example, by means of a routing protocol such as the open shortest path first (OSPF) protocol as defined by RFC 2328 of said IETF.

In conventional manner, the domain N₁ is associated with a network management system TE.

A network management system is a modular system combining various tools enabling the operator of a network or a network domain to manage various aspects thereof: handling breakdowns, traffic, call charging, etc.

In the context of the present invention, this network management system need be no more than a traffic engineering (TE) tool.

The gateways G₁, G₂, and G₃ send information (respectively I₁, I₂, and I₃) to the network management system TE. This information may be sent periodically at the initiative of the gateways themselves, or it may be sent at the initiative of the network management system TE.

This information is representative of the load and/or the status of each of the gateways. The network management system TE can thus be aware of the status of the various gateways, i.e. whether they are operational or not, and how heavily they are loaded.

As a function of this information, the network management system TE can:

select gateways suitable for use for inter-domain transmission. For this purpose, the network management system can exclude any gateways that have failed, e.g. because of a hardware or software breakdown;

put the gateways in an order, e.g. as a function of their respective loadings and/or capacities.

Ordering may be done in such a manner that the gateway having the greatest amount of availability is at the top of the list, and so on down to the last gateway which is the least available gateway. The availability of each gateway can depend on its capacity, since, in practice, each gateway may be of a different model, or indeed from a different manufacturer. Availability may also depend on the loading of each gateway which is a function of the real traffic being conveyed by the gateways. This loading is sent directly by the gateways G₁, G₂, and G₃ by means of the information I₁, I₂, and I₃.

The network management system TE also has means for sending the address of one or more of these gateways to the domain name server DNS associated with the domain N₁.

In a first embodiment of the invention, the network management system TE sends only the address of the “best” gateway to the domain name server DNS. This address can be transmitted to the domain name server by means of a dynamically updated command. This dynamically updated command may, for example, be the “DNS update” command as defined by IETF's RFC 2136 entitled “Dynamic update in the domain name system”.

This dynamic update command enables apparatus outside the domain name server DNS to modify the internal tables of the DNS. In particular, it makes it possible to add a correspondence between a symbolic name corresponding to domain N₂ and the address of the gateway as determined by the network management system TE.

The network management system TE can send a new address regularly, whenever conditions relating to the gateways G₁, G₂, and G₃ change. For example, if it finds out that one of the gateways has ceased to operate, it can then transmit the address of a new gateway to the domain name server DNS. Similarly, if the share of loading between the gateways varies, it can likewise transmit the address of another gateway.

When the router R₁ seeks to send a data packet to the domain N₂it begins by sending a request to the domain name server DNS, which request includes a symbolic name corresponding to the domain N₂.

The domain name server DNS then consults its internal tables. Because of the updating mechanism implemented by the network management system, the domain name server DNS possesses the address of the gateway which is the “best” at a given instant.

This address is associated by the above-described dynamic updating mechanism with the symbolic name contained in the request.

The domain name server DNS thus sends the address of the “best” gateway to the router R₁ using the usual mechanism for communication between routers and domain name servers. The router R₁ can then send the data packet to the domain N₂, using the gateway that is considered to be the “best” by the network management system at that given instant.

The gateway then sends the data packet to the router R₂ which can forward it into the domain N₂.

In a second embodiment of the invention, the network management system TE sends the addresses of a plurality of gateways to the domain name server in the form of a list.

This list may be ordered prior to being sent to the domain name server DNS.

The criteria selected for ordering the gateways may be their respective loadings and/or their respective available resources, in the same manner as is used for determining the “best” gateway in the first embodiment.

In the same manner as described for the first embodiment, the optionally ordered list of gateway addresses can be transmitted by means of a dynamic update command, e.g. of the “DNS update” type in compliance with IETF's RFC 2136.

In this embodiment, a new type of entry needs to be provided in the internal tables of the domain name server, and similarly the dynamic update command is to be designed to contain a list of addresses.

The internal tables of the server can then have a type of entry which consists in establishing a relationship between a symbolic name and a list of addresses.

Thereafter, the mechanism proceeds as in the prior art and as in the above description for the first embodiment: a router R₁ seeking to transmit a data packet to the domain N₂ begins by sending a request to the domain name server DNS containing a symbolic name corresponding to the domain N₂. The domain name server DNS then sends the list associated with the symbolic name contained in the request.

The router R₁ then has a list of available gateways enabling it to access the domain N₂.

Its selection may consist merely in using the first address in the list.

This method of operating enables the router R₁ to have the complete list of available gateways immediately. Thus, if the first gateway should become unavailable in the time interval concerned, or if the route between said router R₁ and the gateway were to be wrongly configured, it is then easy for the router R₁ to turn to the following gateway in the list without needing to interrogate the domain name server again.

What is claimed is:

1/ A network management system having means for obtaining information about equipment in the network, some of said equipment being constituted by gateways suitable for enabling traffic to be sent out from said network, the system including means for sending, to the domain name server associated with said network, the address(es) of one or more of said gateways as determined on the basis of said information.

2/ A network management system according to claim 1, in which said means are arranged to order a list of gateways prior to sending the list to said domain name server.

3/ A network management system according to claim 1, in which said means implement a dynamic update command to send said address(es).

4/ A network management system according. to the preceding claim, in which said command is designed to contain a list of addresses.

5/ A network management system according to claim 3, in which said command is of the “DNS update” type in accordance with RFC 2136.
